(19) United States
(12) Patent Application Publication
(10) Pub. No.: US 2014/0258144 A1
(43) Pub. Date: Sep. 11, 2014

(54) Method of Virtual Patent Marking

(71) Applicant: SEIKO EPSON CORPORATION, Tokyo (JP)

(72) Inventor: Smith Timothy, Nagano-ken (JP)

(73) Assignee: SEIKO EPSON CORPORATION, Tokyo (JP)

(21) Appl. No.: 13/788,214

(22) Filed: Mar. 7, 2013

(51) Int. Cl. G06Q 10/00

(52) U.S. Cl. CPC G06Q 10/00
USPC 705/310

(57) ABSTRACT

A method of virtual patent marking an article that is patented by a patent, includes preparing an in-house document that includes an indicator of the article, the number of the patent in association with the indicator, and other information related to the article. An address on the Internet together with at least one of the word “patent” and the abbreviation “pat.” is fixed on at least one of the article and a label that is fixed to at least one of the article or on a package of the article. A posting is created by carving out an integral section of the in-house document away from the other information. The integral section includes the indicator of the article and the number of the patent in association with the indicator. The posting is then set up at the address on the Internet.

### BACKGROUND

Damages for patent infringement can be calculated from the day on which constructive notice of the patents was first given. The Leahy-Smith America Invents Act (AIA), which was signed into law on Sep. 16, 2011, includes an amendment to 35 U.S.C. §287 that enables “virtual patent marking” as a means of notifying the public that an article is patented, “by fixing thereon the word ‘patent’ or the abbreviation ‘pat.’ together with an address of a posting on the Internet, accessible to the public without charge for accessing the address, that associates the patented article with the number of the patent . . . ” As with conventional patent marking, the notification can also be achieved by fixing a label containing the notice to the article or to the package of the article when the character of the article does not allow for direct attachment of the notice on the article.

U.S. Patent Publication 2012/0096027 discloses a Digital Patent Marking Method.

### SUMMARY

Virtual patent marking greatly simplifies many aspects of patent marking. For example, once the address (URL) of the posting on the Internet has been decided, there is no need to change the patent marking fixed to a product, even if new relevant patents are granted, or old patents expire.

The inventor discovered that virtual patent marking brings with it a new set of challenges:

The “posting” that associates the patented article with the number of the patent needs to be prepared. This can be especially burdensome when different information required for the posting is under the management of different entities, such as different companies, different departments within the same company, or even different people in different countries in the case of a global corporation.

When patent marking is performed in the conventional manner of marking a patent number directly on a product, on a label attached to the product, or on the package of the product, there can be no question as to what product is intended to be marked, because the patent number is physically associated with the patented product. In contrast, in the case of virtual patent marking, there is the potential for confusion if the patented product is not identified in the posting in a manner that is unambiguously clear to anyone interested in what products are covered by what patents.

Once the initial posting is prepared, it must be posted on the Internet. Since this is not the case when patent numbers are fixed directly on a product or product package, a new system will need to be established for patent marking purposes. People and departments that have not been involved with patent marking up to now might need to be involved, which could lead to confusion or errors. Therefore, a simple scheme for virtual patent marking is desirable.

Before the possibility of virtual patent marking, patent marking could only be initiated by marking patent numbers directly on a patented product, on a label attached to the product, or on the product packaging. As a result, the timing of patent marking could at the earliest be when a patented product is introduced into the market. However, which products are covered by which patents is often known far in advance of when products are actually introduced into the market. In fact, in-house patent marking systems in existence from before virtual patent marking often incorporate such advance knowledge of patented products and associated patents, and use the advance knowledge during the design stage of the product or product's packaging to insure that the product or packaging is properly marked when the product is first introduced into the market. If these in-house systems are used for virtual patent marking, patent marking might start before the product is introduced into the market, which would result in confusion.

On the other hand, the longer that the virtual patent marking is delayed, the greater the potential reduction in damages. Therefore, a scheme is needed that improves likelihood that the timing at which the posting is updated will match, as closely as possible, the timing of when new patented products are introduced into the market.

After the posting is posted on the Internet, it must be updated to take into account new patents that are granted, new patented products, old patents that expire, and old products that are discontinued. This can be especially burdensome when different information required to properly update the posting, such as the product model numbers, relevant patent numbers, launch dates of the products and the management of the website page are under the management of different entities, such as different companies, different departments within the same company, or even different people in different countries in the case of a global corporation.

U.S. Patent Publication 2012/0096027 discloses an engine for gathering information about virtually marked patents. However, it is not worth the effort to produce such an engine for smaller companies with only a small patent portfolio, or when a company desires to use only a small portion of its entire portfolio for patent marking purposes.

The URL fixed to the product needs to be selected to avoid confusing customers. This is especially true if the same product is sold in countries other than the United States, where customers will not expect there to be information about United States' patents on a product they purchase.

### BRIEF DESCRIPTION OF THE DRAWINGS

FIG. 1 schematically shows departments involved in implementing a virtual patent marking method according to an embodiment of the present invention;

FIG. 2 shows an in-house document according to the embodiment;

FIGS. 3A and 3B are side and top views respectively of an ink cartridge with a virtual patent marking notice according to the embodiment;

FIG. 4 is a perspective view of a package with a virtual patent marking notice according to the embodiment;

FIG. 5 shows an integral section being carved from the in-house document of FIG. 2;

FIG. 6 shows a posting created by attaching the integral section of FIG. 5 to a heading section;

FIG. 7 shows a modification of the in-house document of FIG. 2;

FIG. 8 shows an integral section being carved from the in-house document of FIG. 7; and

FIG. 9 shows a posting created by attaching the integral section of FIG. 8 to a heading section.

### EMBODIMENT

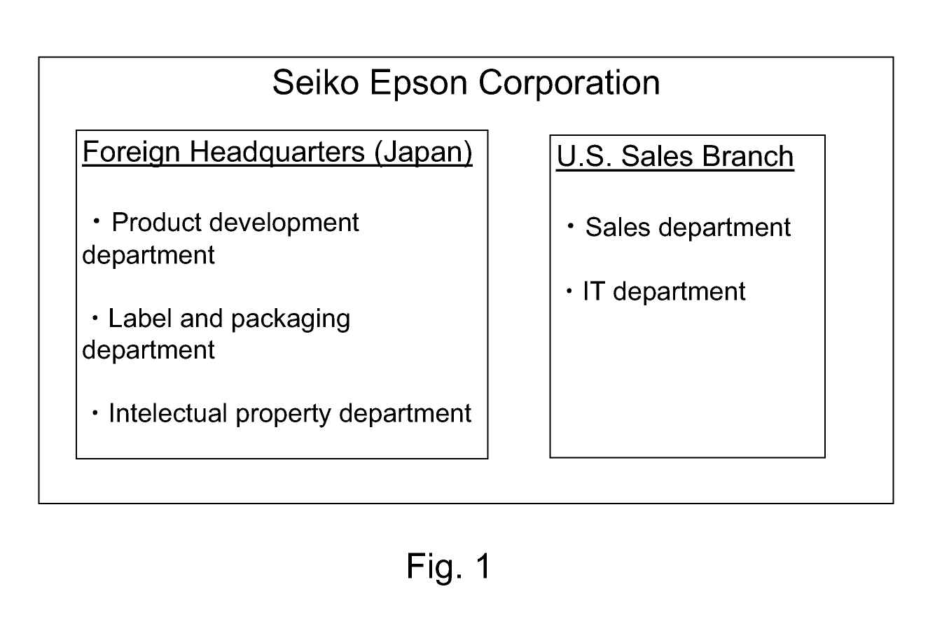

An embodiments of the invention will be described with reference to the accompanying drawings. The embodiment describes a method of virtually marking ink cartridges produced by a printer manufacturer. As shown in FIG. 1, the printer manufacture's headquarters is based in a foreign country, such as Japan, and has a sales branch in the United States.

The headquarters includes a product development department, a label and packaging department, and an intellectual property (IP) department. The product development department designs new model printers and ink cartridges that are to be used in the new printers. The label and packaging department designs labels to be attached to the cartridges and boxes that the cartridges are sold in. The IP department works with the product development department to acquire patent rights in the United States for inventions generated during design of the printers and ink cartridges.

The U.S. branch includes a sales department and an IT department. The sales department determines the timing of when sales of new model printers and the corresponding cartridges are to start. The IT department manages the website of the U.S. sales branch.

The embodied method includes the four steps of preparing an in-house document relating to patent marking, fixing the patent marking to the ink cartridge, creating a posting based on the in-house document, and setting up the posting on the Internet.

### Preparing an In-House Document

An in-house document or other record is kept of which products are marked with which patents. To facilitate in-house communication, the in-house document includes a variety of information about the products and patents, such as in-house nicknames and codes for the products, numbers or codes designating the design specifications for the products, and the like.

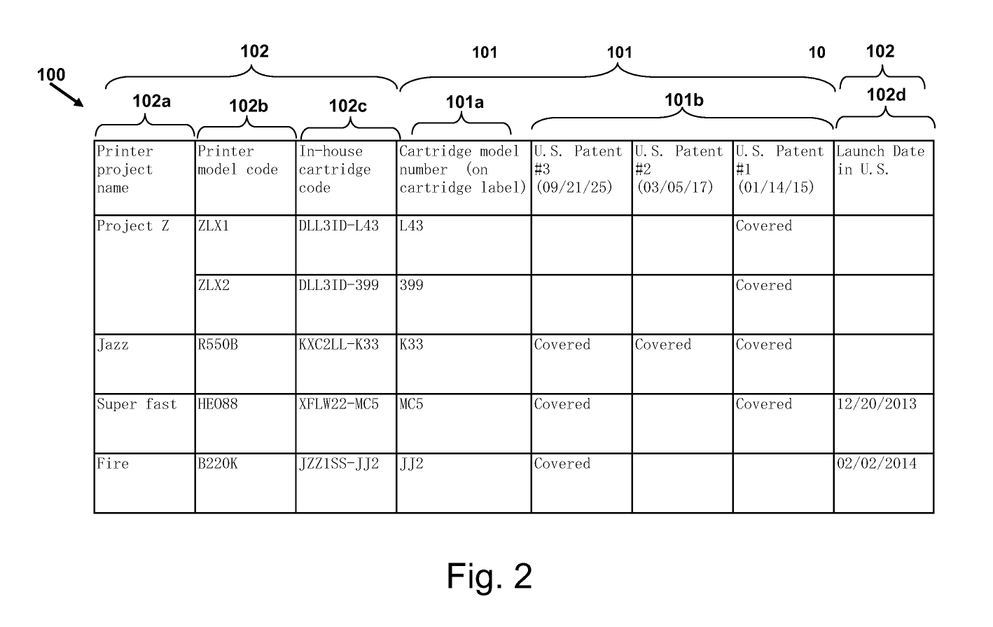

FIG. 2 shows an in-house document 100 according to an embodiment of the invention. The document 100 is produced for managing patent marking and includes posting information 101 and other information 102.

The posting information 101 includes the information required by 35 U.S.C. 287 for proper virtual patent marking. In the present embodiment, the posting information includes indicators 101a of ink cartridges and patent number(s) 101b of associated patents for which 35 U.S.C. 287 notice to the public is desired to be given. In this embodiment, the posting information 101 is listed in matrix form, with the indicators 101a listed vertically and the patent numbers 101b listed horizontally. An ink cartridge that is covered by one of the listed patents is indicated thus using the word “Covered” in the corresponding cell of the matrix. The posting information 101 is all located in adjacent cells of the matrix, so that when the posting is prepared at a later step, all information that is necessary for the posting can be carved out of the matrix away from the other information 102.

The indicator 101a could be any information that would allow someone interested in knowing which patents cover a particular ink cartridge. In this embodiment, the indicators 101a are the cartridge model numbers printed on the cartridge labels, because a person who wishes to know about which patents cover the ink cartridge would most likely have a sample cartridge at hand, and therefore have easy access to the model number printed on the label. The indicator 101a could also or alternately be the model number of the printer in which a cartridge is to be used, or some other information that would achieve this goal.

Along with the patent numbers 101b, the expiry date of each patent is shown in parenthesis after the patent number, in the same cell as the patent number.

The other information 102 includes the printer project name 102a, the printer model code 102b, the in-house cartridge code 102c, and the launch date 102d in the U.S. Various entities (such as different departments, affiliated companies, and patent attorneys) are involved in the virtual patent marking process, and not all entities have access to or understand the posting information 101. The other information 102 allows all entities involved in the virtual patent marking process to access information they need to perform their required tasks. Unlike the posting information 101, the other information 102 need not be provided in adjacent cells of the matrix. For example, in this embodiment, the printer project name 102a, the printer model code 102b, and the in-house cartridge code 102c are listed to the left of the cartridge model numbers 101a and the U.S. patents numbers 101b, and the launch date 102d in the U.S. is located to the right of the cartridge model numbers 101a and U.S. patents numbers 101b.

In the present embodiment, the in-house document is prepared in Excel®. However, any other software with a spreadsheet creating function could be used instead. Alternatively, the in-house document could be prepared in or converted to Portable Document Format (PDF), or other format.

Here an example of how the in-house document 100 is prepared will be provided with reference to FIG. 2. In this example, U.S. Patent #3 is recently allowed. Once U.S. Patent #3 is allowed, the IP department requests the product development department for candidate cartridges that might be covered by U.S. Patent #3. In this example, the product development department indicates that cartridges for printers developed as part of the “Jazz” and “Super Fast” printer projects, and also cartridges that were developed as part of the “Fire” printer project might be covered by U.S. Patent #3. The IP department determines (based on consultations with a U.S. patent attorney, for example) that U.S. Patent #3 covers all three of these cartridge types, and so adds a new column for Patent #3 in the in-house document 100. Because this is the first time the “Fire” project cartridge has been determined to be covered by a patent, the IP department also adds a new row for this cartridge to the matrix. The IP department designates in the patent number(s) 101b section, that the cartridges for printers developed as part of the “Jazz”, “Super Fast”, and “Fire” printer projects are covered by the new U.S. patent #3.

The product development department designs new ink cartridges in coordination with the design of the printer in which the cartridge is to be used, so usually refers to cartridges by the printer project name 102a and the printer model code 102b. The product development department is also responsible for designating an in-house cartridge code 102c for new cartridges, so also has this information. Therefore, the product development department adds the printer project name 102a, the printer model code 102b, and the in-house cartridge code 102c that correspond to the “Fire” project cartridge to the in-house document 100.

The label and packaging department refers to the in⁻house cartridge code 102c that is designated for the cartridge, and adds the cartridge model number 101a, which appears on the label it has designed for the cartridge. In this example, the cartridge model number 101a is the last three digits of the in-house cartridge code 102c.

The sales department of the U.S. sales branch adds the launch 101d date for sales of the cartridge in the U.S. The sales department may refer to the in-house model code 101c to determine the target cartridge, because it may have limited access to the cartridge model number 102a that appears on the label (i.e., may not know the cartridge model number 102a without opening cartridge cartons and boxes to confirm the label name). As described later, the IT staff in charge of the U.S. sales affiliate's web site will use the launch dates to adjust timing of setting the posting on the Internet.

In addition to the above scenario, when the product development department designs a new ink cartridge, the product development department requests that the IP department to determine whether a new ink cartridge is covered by any of the company's U.S. patents. The IP department designates which patents cover the cartridge in the patent number(s) 101b section of the in-house document 100. The other departments add information to the in-house document in a manner similar to that described above.

### Fixing the Patent Marking to the Ink Cartridge

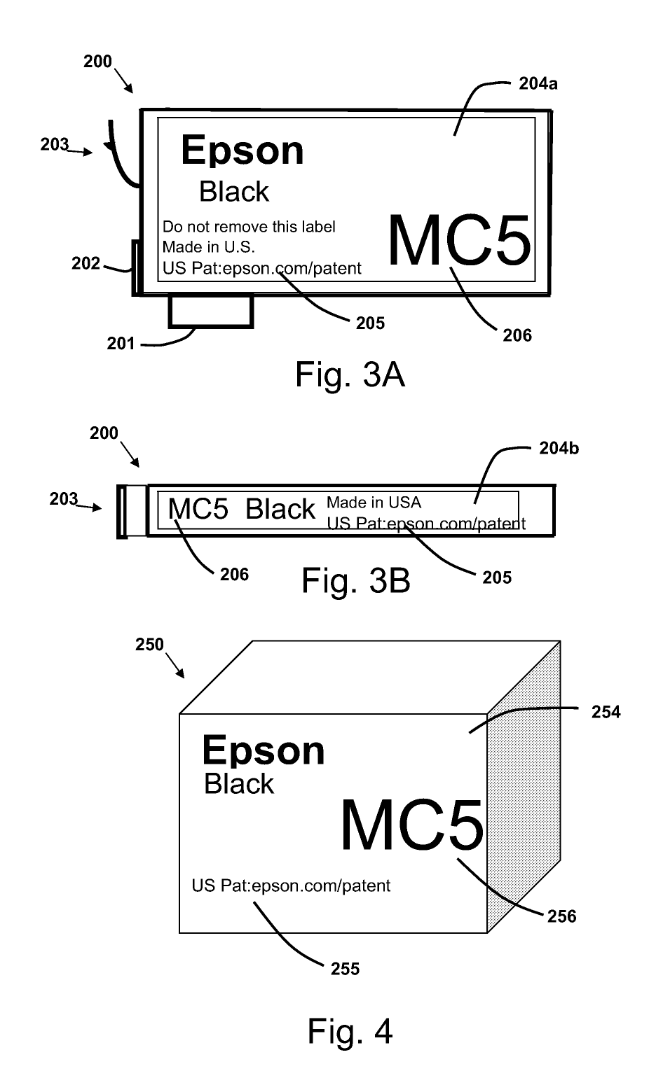

FIGS. 3A and 3B are side and top views respectively of an ink cartridge 200. The ink cartridge 200 includes a supply port 201, an integrated chip (IC) 202, a lever 203 for engaging with a printer in which the cartridge 200 is to be used, a side label 204a, and a top label 204b. The labels 204a, 204b are printed with various information including a virtual patent marking notice 205 and an indicator 206. In this embodiment, the virtual patent marking notice 205 is “U.S. Pat: epson.com/patent”, and the indicator 206 is the same as associated in the in-house document with the cartridge 200. The labels 204a, 204b could be integral or separate.

In the present embodiment, it is assumed that the virtual patent marking notice 205 is printed on both the labels 204a, 204b, or said differently, is “fixed” on the labels 204a, 204b. However, the virtual patent marking notice 205 could be printed on only one of the labels 204a, 204b. Also, in addition to, or instead of, fixing the virtual patent marking notice 205 on the labels 204a, 204b, the virtual patent marking notice 205 could be fixed directly to the ink cartridge 200. In addition, or alternately, as shown in FIG. 4 a virtual patent marking notice 255 could be fixed on the label 254 of a package 250 that contains one or more of the cartridges 200. The label 254 could be could be printed directly on the material of the package 250, or a separate printed label that is adhered to the package 250.

### Creating a Posting Based on the In-House Document

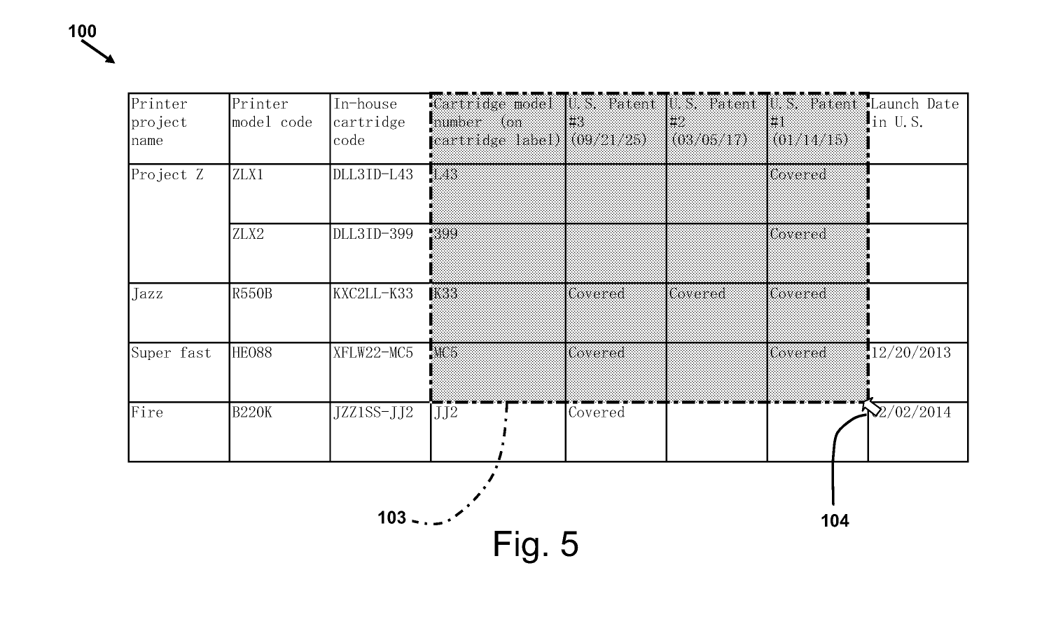

As shown in FIG. 5, to create a posting, an integral section 103, which includes the posting information 101, is carved out of the in-house document 100 away from the other information 102 of in-house document 100. In this embodiment, the integral section 103 is also carved away from the posting information 101 about cartridges that have not been launched yet, based on the launch date information 102d. Specifically, the launch date for cartridge model MC5 is in the past, so the posting information 101 for MC5 is included in the integral section 103. On the other hand, all information for the cartridge model JJ2 is omitted because MC5's launch date is still in the future.

This carving-out step can be accomplished by highlighting the cells of the posting information 102 in the in-house document 100, and then copying the cells. The cells could be highlighted using a mouse-driven cursor 104, or any other well-known means.

The posting will need to be updated from time to time as new patented ink cartridges are introduced and as new patents are granted that cover one or more of the ink cartridges. Whether a new cartridge is covered by any patents will usually be known before the new cartridge is actually launched in the U.S. However, if the posting is updated before the new cartridge is launched, confusion could result. To avoid this, the IT staff in charge of the web site refers to the launch date 102 to adjust timing of setting the posting on the Internet as will be described later.

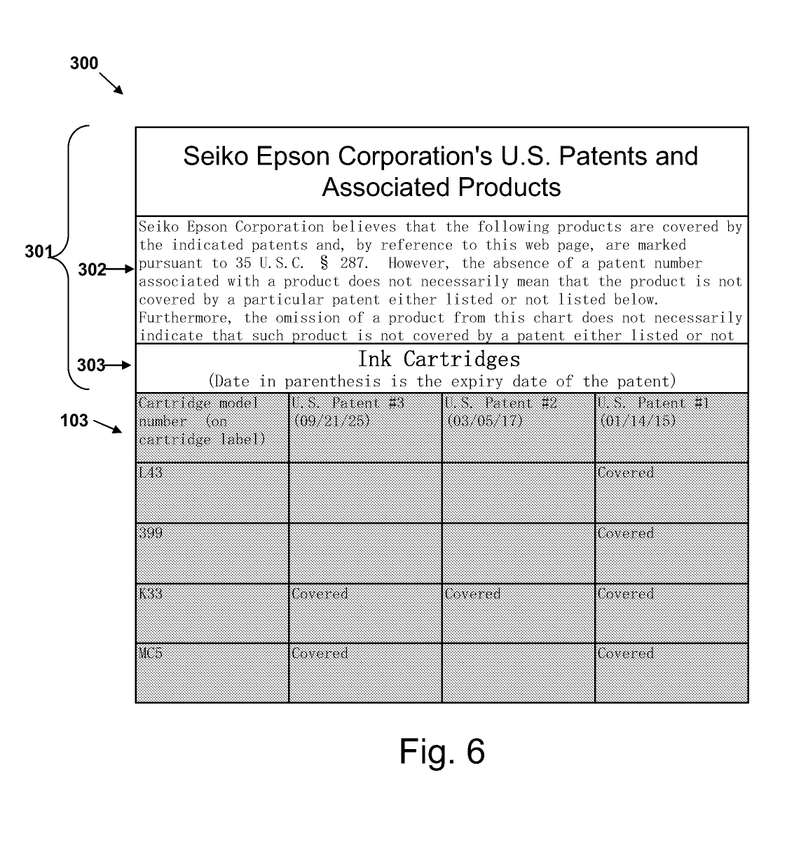

As shown in FIG. 6, the integral section 103 is attached to a heading section 301 to create a posting 300. The heading section 301 of the posting 300 includes a caveat 302 that points out that just because a patent number is not associated with a particular ink cartridge does not necessarily mean that the ink cartridge is not covered by the patent, whether the patent is listed in the posting or not. The caveat 302 also indicates that the omission of an ink cartridge from the posting does not necessarily indicate that the ink cartridge is not covered by any patents, whether listed in the posting or not. The heading section 301 also includes an explanation 303 that the expiry date of each patent is shown in parenthesis after the patent number.

The posting 300 can be in the same format as the in-house document, that is, Excel ®, in Portable Document Format (PDF), or other format.

### Setting Up the Posting on the Internet

The IT department of the U.S. sales branch then uploads the posting 300 to the URL indicated in the patent marking 205 on the ink cartridge and the patent marking 255 of the package. It is preferable that the posting 300 be in HTML format on the Internet site to insure that anyone with an Internet browser of any kind will be able to access the posting on the Internet. If the posting 300 is not in HTML format when initially created, then the posting will need to be converted to HTML format before setting up the posting on the Internet.

The posting 300 will need to be updated from time to time as new patented ink cartridges are introduced and as new patents are granted that cover one or more of the ink cartridges. Whether a new cartridge is covered by any patents will usually be known before the new cartridge is actually launched in the U.S. However, if the posting is updated before the new cartridge is launched, confusion could result. To avoid this, the IT staff in charge of the web site refers to the launch date 102, and updates the posting after the new cartridge is launched.

### Modifications to the Embodiment

An exemplary embodiment of the present invention has been described above. Those skilled in the art will understand, however, that changes and modifications may be made to the embodiment without departing from the scope of the invention, which is defined by the appended claims.

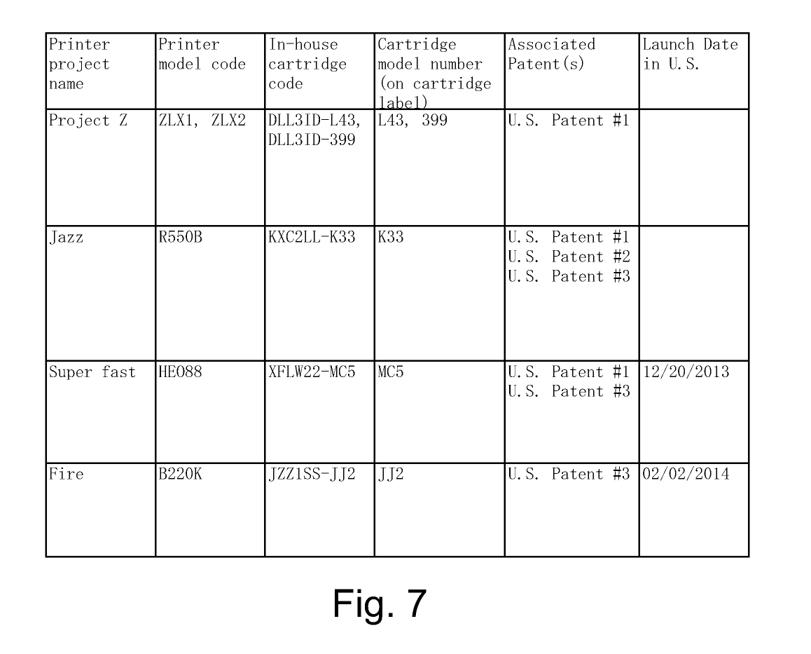

For example, the in-house document can be modified to consolidate the posting information to a greater extent than the posting information 101 shown in FIG. 2. For example, more than one ink cartridge can be indicated in the same cell when the associated patent or patents are the same. In the example shown in FIG. 7, the cartridge models L43 and 399 are both covered by patent #1, so are located in the same cell. Also, patents that cover any particular ink cartridge or cartridges can be located together in the same cell next to the cell of the covered ink cartridge or ink cartridges. In the example shown in FIG. 7, ink cartridge model K33 is covered by the U.S. patents #1, #2, and #3, so U.S. patents #1, #2, and #3 are indicated in the same cell next to ink cartridge model 533. Similarly, ink cartridge model MC5 is covered by the U.S. patents #1 and #3, so both U.S. patents #1 and #3 are indicated in the cell next to ink cartridge model MC5. Although not shown in FIG. 7, if plural ink cartridges are covered by the same plural patents, then one cell with the patents can be located adjacent to a single cell that includes all the covered plural ink cartridges. Also, the cartridge model numbers and patents covering them need not be located in separate cells of the matrix. For example, ink cartridges L43 and 399 could be indicated as “L43, 399: U.S. Patent #1”, and ink cartridge K33 could be indicated as “K33: U.S. Patents #1, #2, #3.” In this case, the cells with “L43, 399: U.S. Patent #1” and “K33: U.S. Patents #1, #2, #3” would be located adjacent to each other in the matrix of the in-house document, and in the step of making the posting, carved out together as an integral section from the other cells of the in-house document.

Although in the embodiment, the in-house document shows the expiration date of each patent, as shown in the example of FIG. 7, the expiration date can be omitted.

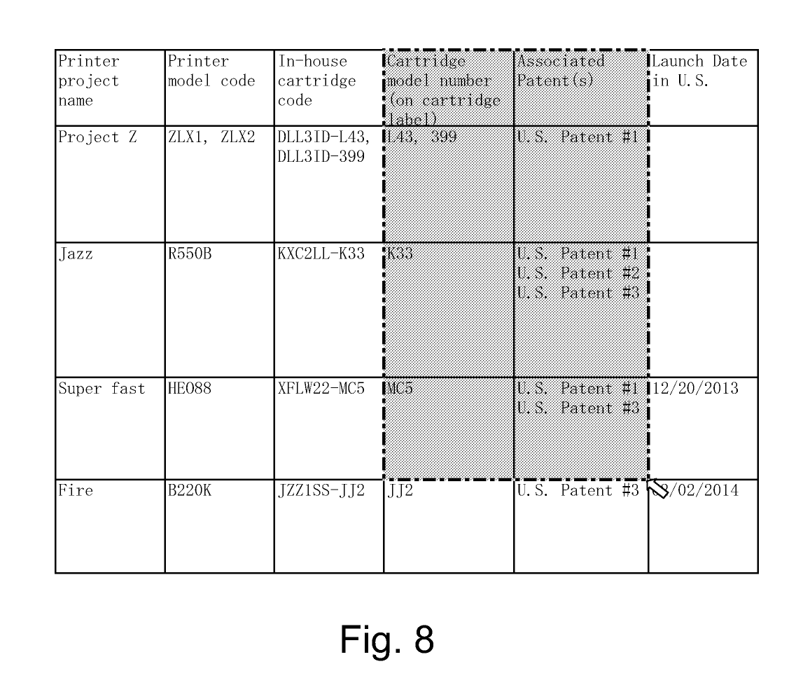

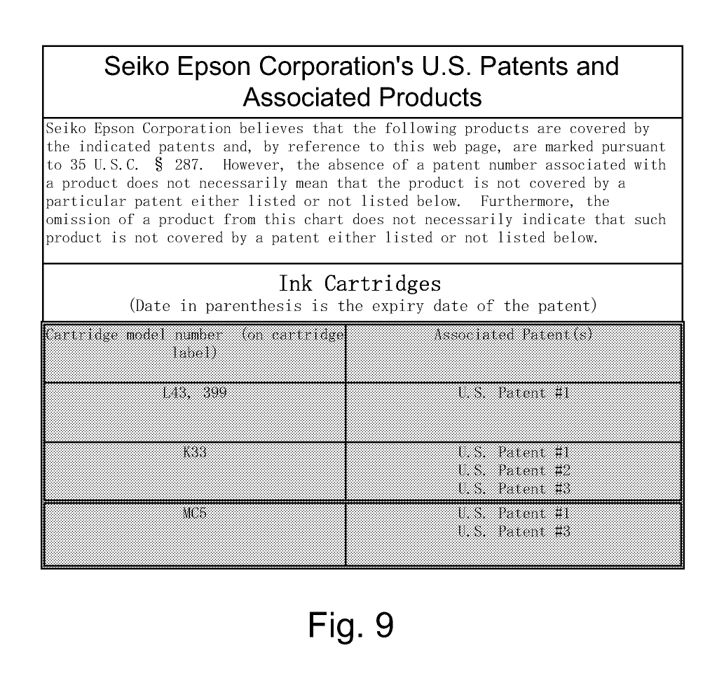

As shown in FIGS. 8 and 9, the in-house document shown in FIG. 7 can be used to prepare a posting in a manner similar to that described with reference to FIGS. 5 and 6.

Also, although the embodiment uses ink cartridges as the target article of virtual patent marking, any other patented product or article could be used instead.

The heading section 301 can be dispensed with and the carved-out integral section 103 itself can be used “as is” as the posting.

Because the virtual patent marking method is simple, even people and departments that have not been involved with patent marking up to now can perform their required tasks without confusion or errors. For example, because the in-house document 100 is in matrix form and includes various information 101, 102, it can be easily understood by everyone involved in the virtual patent marking process, so is easy to create and maintain, even when the different information required for the posting is under the management of different entities, such as different companies, different departments within the same company, or even different people in different countries in the case of a global corporation. Moreover, because the posting information 101 is all located within the integral section 103, the posting 300 can be easily created using the integral section 103 that was carved from the in-house document 100.

Because an indicator 206 that is printed on the label of the ink cartridge 200, or directly on the cartridge 200, is used as the indicator 101a in the integral section 103 of the in-house document 100, and hence in the posting 300 itself, the patented cartridges can be identified in the posting 300 in a manner that is unambiguously clear to anyone interested in what cartridges are covered by what patents.

Because the in-house document 100 includes the launch date 102d, the IT department will be sure not to update the posting 300 until after sales of a new cartridge starts in the U.S., thereby avoiding confusion. Also, the IT department will be able to update the posting 300 immediately after sales begin, so that the period for calculating damages can be maximized.

The URL fixed to the product includes the assignee's (Epson) name and “patents”, so is intuitive for someone looking for patent marking information. Also, the patent marking indicates “U.S.” patents, so even if the patented article is sold outside the United States, customers will not be confused or concerned by the label and the posting.

What is claimed is:

1. A method of virtual patent marking an article that is patented by a patent, the method comprising:
preparing an in-house document that includes an indicator of the article, the number of the patent in association with the indicator, and other information related to the article;
fixing on at least one of the article and a label that is fixed to at least one of the article or on a package of the article, an address on the Internet together with at least one of the word “patent” and the abbreviation “pat.”;
creating a posting by carving out an integral section of the in-house document away from the other information, the integral section including the indicator of the article and the number of the patent in association with the indicator; and
setting up the posting at the address on the Internet.

2. The method of claim 1, wherein the integral section carved from the in-house document includes the expiry date of the patent in association with the number of the patent.

3. The method of claim 1, wherein an alphanumeric sequence fixed on the at least one of the article and the package of the article is used as the indicator of the article in the posting.

4. A method of virtual patent marking an article that is patented by a patent, the method comprising:
preparing an in-house document that includes an indicator of the article, the number of the patent in association with the indicator, and other information related to the article;
fixing on at least one of the article and a label that is fixed to at least one of the article or on a package of the article, an address on the Internet together with at least one of the word “patent” and the abbreviation “pat.”
carving out an integral section of the in-house document away from the other information, the integral section including the indicator of the article and the number of the patent in association with the indicator; and
posting the integral section at the address on the Internet.

5. The method of claim 4, wherein the integral section carved from the in-house document includes the expiry date of the patent in association with the number of the patent.

6. The method of claim 4, wherein an alphanumeric sequence fixed on the at least one of the article and the package of the article is used as the indicator of the article in the posting.
